(19) United States
(12) Patent Application Publication
(10) Pub. No.: US 2023/0268546 A1
(43) Pub. Date: Aug. 24, 2023

(54) BATTERY CELL

(71) Applicant: HONDA MOTOR CO., LTD., Tokyo (JP)

(72) Inventors: Kenta UMETSU, Saitama (JP); Takashi TOYOSHIMA, Saitama (JP); Yohei NOJI, Saitama (JP); Kosei MIYATA, Saitama (JP)

(21) Appl. No.: 18/169,832

(22) Filed: Feb. 15, 2023

(30) Foreign Application Priority Data
Feb. 24, 2022 (JP) 2022-026392

(51) Int. Cl. H01M 10/0525; H01M 10/0562; H01M 4/36

(52) U.S. Cl. CPC H01M 10/0525; H01M 10/0562; H01M 4/366

(57) ABSTRACT

To provide a battery cell capable of suppressing deposition of dendrites and improving cycle characteristics. A battery cell having a negative electrode layer, an electrolyte layer, and a positive electrode layer, the negative electrode layer comprising a negative electrode active material layer that has at least one recess portion and at least one planar portion on a surface of the negative electrode active material layer, the surface being adjacent to the electrolyte layer, the recess portion being a cone or pyramid-shaped recess portion having a slant portion. The negative electrode active material layer comprises lithium metal, and the electrolyte layer is preferably a solid electrolyte layer comprising a solid electrolyte. When the at least one recess portion and the at least one planar portion comprise a plurality of recess portions and a plurality of planar portions, respectively, each of the planar portions is formed between the plurality of recess portions.

This application is based on and claims the benefit of priority from Japanese Patent Application No. 2022-026392, filed on 24 Feb. 2022, the content of which is incorporated herein by reference.

### BACKGROUND OF THE INVENTION

### Field of the Invention

The present invention relates to battery cells.

### Related Art

Conventionally, secondary batteries such as a lithium-ion secondary battery which have a high energy density have been widely used. In recent years, from viewpoints of improving energy efficiency, reducing negative impacts on the global environment by increasing the share of renewable energy and reducing CO₂, the use of secondary batteries has been considered for various applications such as in-vehicle use. A secondary battery has a structure in which a solid electrolyte (separator) is provided between a positive electrode and a negative electrode and which is filled with a liquid or solid electrolyte (electrolytic solution).

As a negative electrode active material of the secondary battery, metals such as lithium metal are used. However, when lithium metal is used as a negative electrode active material, there is a problem that short circuit occurs due to deposition of dendrites. In particular, in a solid battery having a solid electrolyte, the short circuit may occur when uneven distribution of restraining load occurs.

As a lithium secondary battery negative electrode in which growth of dendrite crystals is suppressed, for example, a technique is known in which a large number of crystals are generated by forming a large number of crystal nuclei serving as crystal growth points in the negative electrode, whereby generation of large dendrite crystals is suppressed (see Patent Document 1).

Patent Document 1: Japanese Unexamined Patent Application, Publication No. H6-84512

### SUMMARY OF THE INVENTION

The technique disclosed in Patent Document 1 is capable of suppressing generation of large dendrite crystals by forming fine irregularities on the substrate surface, but when the technique is applied to, for example, a solid-state battery, a strong restraining load is applied to the electrode, so that generation of even relatively small dendrite crystals may affect battery performance. Therefore, under the current state of development, satisfactory cycle characteristics during charge and discharge of the battery cell have not yet been obtained.

The present invention has been made in view of the above-mentioned circumstances, and it is an object of the present invention to provide a battery cell capable of suppressing deposition of dendrites and improving cycle characteristics.

A first aspect of the present invention relates to a battery cell having a negative electrode layer, an electrolyte layer, and a positive electrode layer, the negative electrode layer including a negative electrode active material layer that has at least one recess portion and at least one planar portion on a surface of the negative electrode active material layer, the surface being adjacent to the electrolyte layer, the recess portion being a cone or pyramid-shaped recess portion having a slant portion.

According to the first aspect, a battery cell capable of suppressing deposition of dendrites and improving cycle characteristics can be provided.

A second aspect of the present invention relates to the battery cell as described in the first aspect, in which the negative electrode active material layer contains lithium metal.

According to the second aspect, even when lithium metal which easily produces dendrites is used as the negative electrode active material, occurrence of short circuit can be suppressed, and a battery cell having preferable cycle characteristics can be provided.

A third aspect of the present invention relates to the battery cell as described in the first or second aspect, in which the electrolyte layer is a solid electrolyte layer including a solid electrolyte.

According to the third aspect, even in a battery cell having a solid electrolyte layer containing a solid electrolyte as the electrolyte layer, occurrence of short circuit can be suppressed, and a battery cell having preferable cycle characteristics can be provided.

A fourth aspect of the present invention relates to the battery cell as described in any one of the first to third aspects, in which the at least one recess portion and the at least one planar portion comprise a plurality of recess portions and a plurality of planar portions, respectively, and the plurality of planar portions are formed in a manner that the plurality of recess portions are not in contact with each other.

According to the fourth aspect, even when a plurality of recess portions is formed in the negative electrode active material layer, no projective portions are formed on a surface of the negative electrode active material layer, the surface being adjacent to the electrolyte layer, and accordingly dendrites can be generated preferentially in the recess portions, which more preferably suppresses occurrence of short circuit of the battery cell.

### BRIEF DESCRIPTION OF THE DRAWINGS

FIG. 1 is a cross-sectional view illustrating a configuration of a battery cell according to an embodiment of the present invention;

FIG. 2 is a top view illustrating a part of the negative electrode active material layer according to an embodiment of the present invention; and

FIG. 3 is a graph illustrating results of cycle characteristic tests using the battery cells of the Example and the Comparative Example.

### DETAILED DESCRIPTION OF THE INVENTION

### Battery Cell

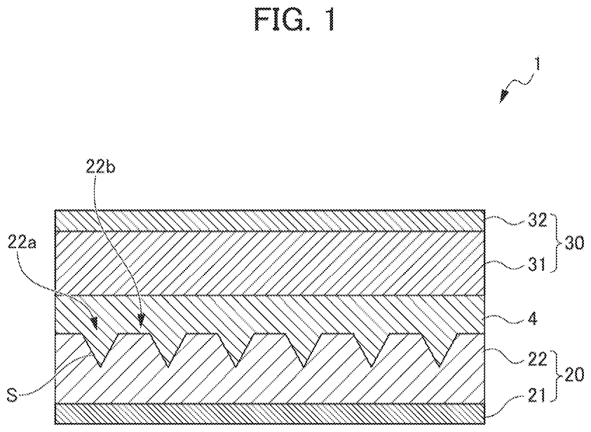

Hereinafter, a battery cell 1 according to an embodiment of the present invention will be described. As shown in FIG. 1, the battery cell 1 according to the present embodiment is formed by laminating a negative electrode layer 20, an electrolyte layer 4, and a positive electrode layer 30 in this order. The battery cell 1 is, for example, a lithium-ion battery cell using lithium ions as a charge transfer medium. The battery cell 1 may be a battery cell having a liquid electrolyte layer 4. On the other hand, since the configuration of the present embodiment shown below can preferably reduce the influence of the deposition of dendrites, the battery cell 1 according to the present embodiment is preferably a battery cell having a solid electrolyte layer 4 which is susceptible to the influence of the deposition of dendrites.

### Negative Electrode Layer

The negative electrode layer 20 is formed, for example, by forming a negative electrode active material layer 22 on a negative electrode current collector 21.

The negative electrode current collector 21 is not particularly limited, and a well-known substance can be applied as the negative electrode current collector of a solid secondary battery. Examples of the negative electrode current collector 21 include copper, stainless steel, and the like. Copper, stainless steel, and the like are molded into, for example, a foil shape and used.

The negative electrode active material layer 22 is a layer containing a negative electrode active material as an essential component. In addition to the negative electrode active material, the negative electrode active material layer 22 may contain a binder, a conductive auxiliary agent, an electrolyte, and the like. The binder, the conductive auxiliary agent, the electrolyte, and the like are not particularly limited, and known substances can be used as the electrode material for a secondary battery.

The negative electrode active material is not particularly limited, and a known substance can be applied as the negative electrode active material for the secondary batteries. On the other hand, the configuration of the present embodiment described below can preferably reduce the influence of deposition of dendrites, which is significant when lithium metal is used as the negative electrode active material. Accordingly, the negative electrode active material layer 22 preferably contains lithium metal as the negative electrode active material.

Examples of the negative electrode active material other than lithium metal include lithium transition metal oxides such as lithium titanate (Li₄Ti₅O₁₂); transition metal oxides such as TiO₂, Nb₂O₃, WO₃, etc.; metal sulfides; metal nitrides; carbon materials such as graphite, soft carbon, hard carbon, etc.; metal indium; lithium alloys; and the like.

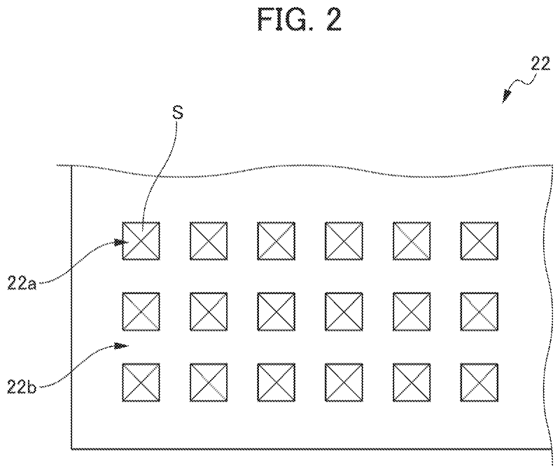

As shown in FIGS. 1 and 2, the negative electrode active material layer 22 has a plurality of recess portions 22a and a plurality of planar portions 22b on the surface of the negative electrode active material layer 22, the surface being adjacent to the electrolyte layer 4.

As shown in FIGS. 1 and 2, a recess portion 22a is a cone or pyramid-shaped recess portion having a slant portion S. Since the recess portions 22a are formed in the negative electrode active material layer 22, the current density varies, and the current density increases in the vicinity of the recess portions 22a. As a result, since dendrites are preferentially generated at the recess portion 22a, the risk that the dendrites break through the electrolyte layer 4 and short circuit occurs can be reduced. Thereby, the cycle characteristics of the battery cell 1 can be improved. In addition to the above, the recess portion 22a can alleviate unevenness of pressure distribution caused by expansion of the negative electrode layer 20 during charge of the battery cell 1. Further, since the contact area between the electrolyte layer 4 and the negative electrode active material layer 22 is increased by the recess portion 22a, resistance is reduced, and thus the output of the battery cell 1 is improved.

Since the recess portion 22a has a shape of cone or pyramid having a slant portion S, a dendrite is likely to be preferentially generated starting from the apex of the cone or pyramid. In FIGS. 1 and 2, the shape of the recess portion 22a is shown as that of a quadrangular pyramid, but the shape of the recess portion 22a may be any one selected from conical or pyramidal shape, and may be a polygonal pyramid other than the quadrangular pyramid, or a circular cone.

The depth of the recess portion 22a is not particularly limited, and the upper limit thereof is the thickness of the negative electrode active material layer 22.

FIG. 2 is a view of the negative electrode active material layer 22 singly viewed from the electrolyte layer 4 side. In FIG. 2, the recess portions 22a are regularly arranged as rectangular openings in a row-like shape, but the arrangement of the recess portions 22a is not limited thereto. The openings of the recess portions 22a may be alternately and regularly arranged, or may be irregularly arranged to some extent. The recess portions 22a are preferably formed on the entire surface of the negative electrode active material layer 22, the surface being adjacent to the electrolyte layer 4.

A planar portion 22b is a face substantially perpendicular to the laminating direction of the negative electrode active material layer 22. The planar portion 22b is a portion where the recess portion 22a is not formed on the surface of the negative electrode active material layer 22, the surface being adjacent to the electrolyte layer 4. The negative electrode active material layer 22 has the planar portion 22b together with the recess portion 22a, and thereby the negative electrode active material layer 22 can be formed without forming a projective portion capable of having a high current density in the negative electrode active material layer 22 closer to the electrolyte layer 4. Therefore, formation of dendrites in a zone close to the electrolyte layer 4 can be suppressed. As shown in FIG. 2, each of the planar portions 22b is preferably disposed between the plurality of recess portions 22a. In other words, it is preferable that the openings of the plurality of recess portions 22a are not in close contact with each other.

### Positive Electrode Layer

The positive electrode layer 30 is formed by forming a positive electrode active material layer 31, for example, on a positive electrode current collector 32.

The positive electrode active material layer 31 is a layer containing a positive electrode active material as an essential component. In addition to the positive electrode active material, the positive electrode active material layer 31 may contain a binder, a conductive auxiliary agent, an electrolyte, and the like. The binder, the conductive auxiliary agent, the electrolyte, and the like are not particularly limited, and known substances can be used as the electrode material of a secondary battery.

The positive electrode active material is not particularly limited, and a well-known substance can be applied as the positive electrode active material of a secondary battery. Examples of the positive electrode active material include layered positive electrode active material particles such as LiCoO₂, LiNiO₂, LiCo_{1/3}Ni_{1/3}Mn_{1/3}O₂, LiVO₂, LiCrO₂, etc., spinel positive electrode active materials such as LiMn₂O₄, Li(Ni_{0.25}Mn_{0.75})₂O₄, LiCoMnO₄, Li₂NiMn₃O₈, etc., and olivine positive electrode active materials such as LiCoPO₄, LiMnPO₄, LiFePO₄, etc.

The positive electrode current collector 32 is not particularly limited, and a well-known substance can be applied as the positive electrode current collector of a secondary battery. Examples of the positive electrode current collector 32 include aluminum and stainless steel. Aluminum, stainless steel, or the like is molded into a foil shape, for example, and used. In addition to the above, a conductive carbon sheet (e.g., a graphite sheet or a CNT sheet) or the like may be used.

### Electrolyte Layer

The electrolyte layer 4 may be a layer containing a solid electrolyte or a layer containing an electrolytic solution in which the electrolyte is dissolved in a nonaqueous solvent. The electrolyte layer 4 is preferably a layer containing a solid electrolyte.

As the solid electrolyte contained in the electrolyte layer 4, a well-known substance as a solid electrolyte usable in a secondary battery can be applied. Examples of the solid electrolyte include a sulfide-based solid electrolyte, an oxide-based solid electrolyte, a nitride-based solid electrolyte, a halide-based solid electrolyte, etc.

As a nonaqueous solvent-soluble electrolyte contained in the electrolyte layer 4, known substances can be applied as an electrolyte usable in a secondary battery.

Examples of the nonaqueous solvent-soluble electrolyte include LiPF₆, LiBF₄, LiClO₄, LiN(SO₂CF₃), LiN(SO₂C₂F₅)₂, LiCF₃SO₃, LiC₄F₉SO₃, LiC(SO₂CF₃)₃, LiF, LiCl, LiI, Li₂S, Li₃N, Li₃P, Li₁₀GeP₂S₁₂ (LGPS) , Li₃PS₄, Li₆PS₅Cl, Li₇P₂S₈I, LiₓPO_{y}N_{z} (x=2y+3z−5, LiPON) , Li₇La₃Zr₂O₁₂ (LLZO) , Li₃ₓLa_{2/3-x}TiO₃ (LLTO), Li₁₊ₓAlₓTi₂₋ₓ(PO₄)₃ (0≤x≤1, LATP), Li_{1.5}Al_{0.5}Ge_{1.5}(PO₄)₃ (LAGP), Li_{1+x+y}AlₓTi₂₋ₓSi_{y}P_{3-y}O₁₂, Li_{1+x+y}Alₓ(Ti, Ge)₂₋ₓSi_{y}P_{3-y}O₁₂, Li₄₋₂ₓZnₓGeO₄ (LISICON), and the like. The above-mentioned electrolytes may be used alone, or in a combination of two or more types thereof.

Examples of the nonaqueous solvent for dissolving the liquid electrolyte include aprotic solvents such as carbonates, esters, ethers, nitriles, sulfones, lactones and the like.

When the electrolyte layer 4 contains an electrolytic solution, the battery cell 1 may include a separator. The separator is positioned between the positive electrode layer and the negative electrode layer. The material, thickness, and the like of the separator are not particularly limited, and a known separator such as polyethylene or polypropylene which can be used in a secondary battery cell can be applied.

### Method of Manufacturing Battery Cell

As the method of manufacturing the battery cell 1 according to the above-mentioned embodiment, a known method of manufacturing a secondary battery can be employed except for the method of forming the negative electrode active material layer 22 having a recess portion and a planar portion on the surface of the negative electrode electrolyte layer, the surface being adjacent to the electrolyte layer.

The negative electrode layer 20 and the positive electrode layer 30 may be formed by any method selected from a wet method and a dry method. For example, when the negative electrode layer 20 and the positive electrode layer 30 are formed by the wet method, a method in which an electrode material mixture slurry containing an electrode active material is applied to a current collector by a known method such as a doctor blade method and dried can be applied.

As a method of forming the negative electrode active material layer 22 having a recess portion and a planar portion, for example, a method of pressing the negative electrode active material layer 22 formed on the negative electrode current collector 21 in the negative electrode layer 20 manufactured as described above, against a surface of a pressing device such as a uniaxial pressing device or a roll pressing device having irregularities formed thereon can be mentioned.

When the electrolyte layer 4 is a solid electrolyte layer having a solid electrolyte, the electrolyte layer 4 can be formed through a step of pressing the solid electrolyte. Alternatively, the electrolyte layer 4 may be formed through a step of coating a surface of a substrate or an electrode with a solid electrolyte paste prepared by dispersing a solid electrolyte or the like in a solvent.

The battery cell 1 is obtained by laminating the negative electrode layer 20, the electrolyte layer 4, and the positive electrode layer 30 in this order to form a laminate. At this time, a step of pressing the laminate may be performed. As a means for pressing, a known means such as a roll press can be used.

The preferred embodiments of the present invention have been described above. The present invention is not limited to the description of the above embodiment, and can be appropriately modified without departing from the gist of the present invention.

### EXAMPLES

Hereinafter, the present invention will be described in more detail based on the Examples and the like, but the present invention is not limited to these Examples and the like.

### Preparation of Battery Cell

### <Example>

Lithium metal serving as a negative electrode active material was bonded to a copper foil serving as a negative electrode current collector by a cladding material, and then pressing was performed using a uniaxial pressing device having irregularities on the surface thereof to prepare a negative electrode active material layer in which recess portions in the shape of quadrangular pyramid and planar portions were regularly arranged on the surface, as shown in FIG. 2. Then, the solid electrolyte layer and the positive electrode layer manufactured by conventional methods and the negative electrode active material layer manufactured by the above method were laminated and integrally pressed to prepare a battery cell according to the Example.

### Comparative Example

A battery cell according to the Comparative Example was manufactured in the same manner as in the Example except that no cone or pyramid-shaped recess portions were formed on the surface of the negative electrode active material layer.

By using the battery cells of the Example and Comparative Example manufactured as described above, initial charge/discharge efficiency (0.1 C, 25° C.) and initial direct current resistance (DCR) (60° C.) were measured, but no significant difference was observed.

### [Cycle Characteristic Test]

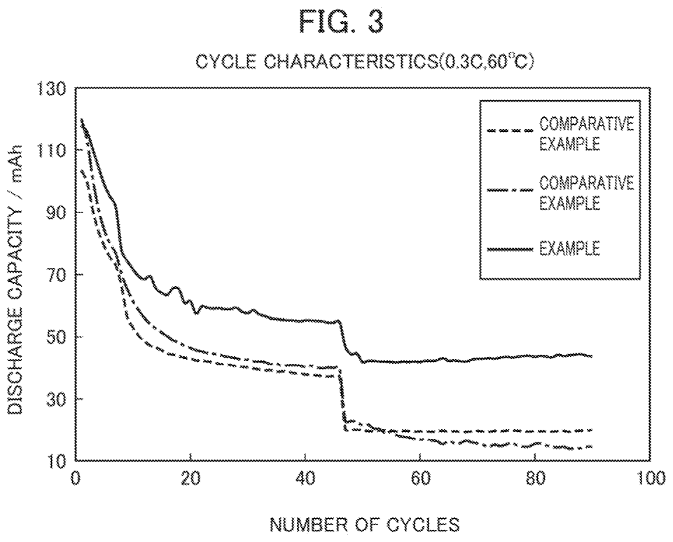

A cycle characteristic test (0.3 C, 60° C.) was performed using the battery cells of the Example and Comparative Example manufactured in the above. Charge and discharge of each of the battery cells of the Example and the Comparative Example was repeated 90 cycles and the relation between the number of cycles and the discharge capacity (mAh) is shown in FIG. 3. In the Comparative Example, the cycle characteristics were tested at N=2. As shown in FIG. 3, when compared with the battery cell of the Comparative Example, the discharge capacity of the battery cell of the Example hardly decreased even when the number of cycles was increased, and the result of excellent cycle characteristics is apparent.

### EXPLANATION OF REFERENCE NUMERALS

1 Battery cell

20 Negative electrode layer

22 Negative electrode active material layer

22a Recess portion

22b Planar portion

30 Positive electrode layer

4 Electrolyte layer

S Slant portion

What is claimed is:

1. A battery cell having a negative electrode layer, an electrolyte layer, and a positive electrode layer,
the negative electrode layer comprising a negative electrode active material layer that has at least one recess portion and at least one planar portion on a surface of the negative electrode active material layer, the surface being adjacent to the electrolyte layer,
the recess portion being a cone or pyramid-shaped recess portion having a slant portion.

2. The battery cell according to claim 1, wherein the negative electrode active material layer comprises lithium metal.

3. The battery cell according to claim 1, wherein the electrolyte layer is a solid electrolyte layer comprising a solid electrolyte.

4. The battery cell according to claim 1, wherein the at least one recess portion and the at least one planar portion comprise a plurality of recess portions and a plurality of planar portions, respectively and each of the planar portions is formed between the plurality of recess portions.
